(19) United States
(12) Patent Application Publication
(10) Pub. No.: US 2004/0070846 A1
(43) Pub. Date: Apr. 15, 2004

(54) Objective

(76) Inventors: Hans-Juergen Dobschal, Kleinromstedt (DE); Klaus Rudolf, Jena (DE); Reinhard Steiner, Stadtroda (DE); Robert Brunner, Jena (DE); Knut Hage, Apolda (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/443,352

(22) Filed: May 22, 2003

Related U.S. Application Data
(60) Provisional application No. 60/382,454, filed on May 22, 2002.

(30) Foreign Application Priority Data
Jun. 22, 2001 (DE) 101 30 212.6

(51) Int. Cl. G02B 9/04

(52) U.S. Cl. 359/795; 359/793

(57) ABSTRACT

In an objective, in particular a microscope objective, wherein the objective has a first optics group on the object side with positive refractive power and a second optics group with negative refractive power following the first optics group, and wherein the first optics group contains a plurality of refractive elements, the first optics group contains at least one diffractive element with a refraction-increasing and achromatizing effect.

### CROSS-REFERENCE TO RELATED APPLICATIONS

This application claims priority of provisional application No. 60/382,454, filed May 22, 2002 and German Application No. 101 30 212.6, filed Jun. 22, 2001, the complete disclosures of which is hereby incorporated by reference.

### BACKGROUND OF THE INVENTION

a) Field of the Invention

The invention is directed to an objective, in particular a microscope objective, this objective having a first optics group on the object side with positive refractive power and a second optics group with negative refractive power following the first optics group, and the first optics group contains a plurality of refractive elements.

b) Description of the Related Art and Recognition of the Problem Addressed by the Invention

A microscope objective of the type mentioned above is used, for example, in microscopes for optical monitoring of masks which are used to fabricate semiconductor components. Masks of this type comprise, e.g., a quartz substrate on which the mask structure is formed by means of chromium. In order to protect this mask, a removable layer of plastic is applied to this quartz substrate, its surface remote of the mask structure having a distance of 7.5 mm from the mask structure. In order to achieve the resolution needed for optical monitoring, the microscope objective has a numerical aperture greater than 0.5. However, in this case, the working distance of the microscope objective is generally less than 1 mm. As a result, the protective layer must be removed in order to inspect the mask. On the one hand, this increases labor for monitoring and, on the other hand, entails the risk of unwanted particles being deposited on the mask, which appreciably reduces the quality of the mask.

Further, in a microscope objective of this kind, it is necessary with wavelengths of less than 266 nm to provide calcium fluoride lenses and quartz lenses for achromatization. However, calcium fluoride is very expensive, extremely difficult to machine with the required accuracy and, further, has disadvantageously hygroscopic characteristics.

### OBJECT AND SUMMARY OF THE INVENTION

Based on the foregoing, it is the primary object of the present invention to further develop an objective, particularly a microscope objective, of the type mentioned in the beginning in such a way that it has a high numerical aperture and a large working distance at the same time.

This object is met in an objective of the type mentioned above in that the first optics group contains at least one diffractive element with a refraction-increasing and achromatizing effect.

In the present connection, the characteristic of positive refractive power or positive action (e.g., of the first optics group) means that the divergence of a beam bundle is reduced or changed to convergence or the convergence is increased. With respect to the first optics group, this applies at least to the light of an order of diffraction of the diffractive element. Accordingly, the diffractive element itself also has a positive refractive power and therefore a refraction-increasing action for the light of the at least one order of diffraction. In the present connection, the characteristic of negative refractive power or negative action (e.g., of the second optics group) means that the divergence of a beam bundle is increased or the convergence of a beam bundle is reduced or also transformed to divergence. Therefore, the achromatizing action of the diffractive element exists for the at least one order of diffraction for which the diffractive element also has a refraction-increasing effect.

In the diffractive element, the objective according to the invention comprises an optics element by means of which, for example, the spherical aberration and coma of the objective according to the invention can advantageously be improved and which, at the same time, further contributes to the achromatization of the objective, since the dispersion of the diffractive element is opposed to the dispersion of the refractive element of the objective according to the invention.

Therefore, calcium fluoride lenses need not be used for achromatization in the objective according to the invention for applications in the UV range (wavelengths less than 300 nm), so that its fabrication is simplified in comparison to a conventional objective which also contains calcium fluoride lenses because of the required achromatization.

In particular, in the objective according to the invention, selection of the materials for the optical elements can be made apart from the required achromatization in favor of other important characteristics (e.g., ease of machining or transmission characteristics), and all optical elements can be produced from the same materials or from different materials.

Further, the diffractive element has a relatively high positive refractive power (or high positive action) compared to a refractive element, so that the quantity of elements of the objective according to the invention is appreciably reduced compared to an objective formed from exclusively refractive elements. This is especially advantageous particularly in high-power objectives which are achromatized for a wavelength range of several nanometers or less because the objective can be produced appreciably more economically and faster by using fewer elements due to the fact that the optical elements must be produced and adjusted with extremely high accuracy.

Further, it is also advantageous that the objective according to the invention can be realized with an overall length that is very much shorter compared to a conventional (purely refractive) objective with the same aperture and the same working distance, so that the objective according to the invention can easily be implemented as an exchangeable objective which can be used in existing equipment, e.g., optical inspection systems and microscopes, without having to modify this equipment. Accordingly, this equipment can easily be retrofitted with the objective according to the invention which has a very high numerical aperture and a very large working distance at the same time.

The diffractive element can preferably be designed in such a way that, in addition to its achromatizing action for the objective and refraction-increasing action for the first optics group, higher-order spherical aberrations generated by the rest of the optical elements of the objective according to the invention can also be compensated.

Further, the diffractive element which performs the achromatizing action in the objective according to the invention avoids the difficulties which arise in an objective comprising exclusively refractive elements as a result of the necessary achromatization, i.e., excessively narrow edge thickness of the lenses and insufficient separation between the lenses particularly at the lens edges, which necessitates extremely complicated mounting techniques. Therefore, in an advantageous manner, the mounting of the optical elements is appreciably simplified in the objective according to the invention. Also, because of this the objective according to the invention can be produced economically and quickly.

In a preferred further development of the objective according to the invention, all of the optical elements of the two optics groups are formed from a maximum of two different materials, preferably from the same material. Since the achromatization is caused by the diffractive element, materials can be selected which are best suited to the spectral range for which the objective according to the invention is to be used. For example, the material with the best transmission characteristics and/or the material which is easiest to machine can be selected. Accordingly, the elements can comprise quartz and/or calcium fluoride, for example.

Suprasil (synthetic quartz) is preferable for a wavelength range of 193 nm±0.5 nm, 213 nm±0.5 nm, 248 nm±0.5 nm and 266 nm±0.5 nm, and calcium fluoride is the preferred material for a wavelength range of 157 nm±0.5 nm.

In particular, the objective according to the invention is designed in such a way that the desired achromatization of the objective for a given wavelength range is caused completely by the at least one diffractive element. When complete achromatization of the objective is desirable, optics arrangements which are arranged following the objective, e.g., a tube lens in a microscope, can be designed so as to be completely independent from the objective with respect to their achromatizing characteristics. Alternatively, partial achromatization of the objective according to the invention may be desirable, in which case the light bundle exiting from the objective is not fully achromatized. In this case, an optics arrangement following the objective (e.g., a tube lens in the case of a microscope) can supply the lacking amount of achromatization if desired.

It is essential in the objective according to the invention that the achromatization of the refractive elements (which are themselves preferably not achromatized at all) of the objective according to the invention is caused substantially or exclusively by the at least one diffractive element (or by a plurality of diffractive elements). The second optics group preferably does not contain any diffractive elements but rather only one individual refractive element or a plurality of refractive elements. But, of course, one or more diffractive elements can also be contained in the second optics group.

In the objective according to the invention, the optical elements of the two optics groups are preferably held without cement. This advantageously eliminates the drawback of aging cement which occurs in systems using optical cement, especially at wavelengths in the UV range, and which poses a great problem. A very long useful period of the objective according to the invention can be ensured in this way.

In the objective according to the invention, the maximum bundle diameter in the first optics group is advantageously greater than the maximum bundle diameter in the second optics group. Accordingly, a high numerical aperture can be realized with a short overall length of the objective according to the invention, so that a high resolution can be achieved particularly when the objective according to the invention is used in a microscope.

The diffractive element of the objective according to the invention is preferably a grating which is rotationally symmetric with respect to the optical axis of the objective, so that the installation and adjustment of the diffractive element in the objective according to the invention is simplified due to this symmetry. This also makes possible a fast fabrication of the objective according to the invention.

In an advantageous further development of the objective, the diffractive element has a transmissive grating, preferably a phase grating, whose grating frequency increases radially outward from the optical axis of the objective. The grating can be formed, for example, by annular recesses arranged concentric to the optical axis. The grating is preferably formed on a plane surface. This plane surface can be either a surface of a plane-parallel plate or a lens of the first optics group. Production of the grating is facilitated by providing the grating on a plane surface.

Alternatively, the grating can also be formed on a curved working surface or boundary surface of one of the diffractive elements of the first optics group. In this case, the quantity of optical elements is advantageously further reduced, so that the objective according to the invention can be manufactured more quickly and economically.

Further, it is advantageous in the objective according to the invention to arrange the diffractive element in the first optics group in the area with the largest bundle diameter because the high refractive power of the diffractive element can be used most effectively in this region. The scatter light (light of unwanted orders) is also cut off to a large extent at the mountings of the lenses following the diffractive element or exits the objective with a distinctly different intersection length than the useful light (used for imaging), so that the scatter light is very greatly expanded and therefore leads, at most, to a very slight impairment of imaging.

In a particularly advantageous manner, the grating is constructed as a blazed grating, so that the light-collecting efficiency of the grating is extremely high for a desired order of diffraction. The light of this order of diffraction is the useful light which is imaged by means of the optical elements of the objective according to the invention following the diffractive element and should exit the objective as a beam bundle that is achromatized.

When the blazed grating is formed by means of the holographic standing wave method, the flanks of the recesses are continuous and need not be approximated by a step function, so that there is advantageously virtually no diffuse scatter light which would impair the imaging characteristic of the objective.

In order to come as close as possible to the theoretically optimal diffraction efficiency in a preferred further development, the recesses of the diffractive element of the objective according to the invention are formed in such a way that the depth of the individual recesses decreases with increasing radial distance of the recess from the center.

Alternatively, the recesses can also be formed in such a way that they are all constructed with identical depth. In this case, production of the grating is facilitated and it can be formed, for example, by means of structuring methods known from semiconductor fabrication.

In a grating with constant depth, it is particularly preferable when the optimal depth for the edge area of the diffractive element is selected as the depth had by all of the recesses, since the edge area, by reason of its larger surface compared to the center area of the grating, contributes most toward light collection and the outer area contributes greatly to the aperture and therefore determines the resolution of the objective according to the invention to the greatest degree. For the same reason, in the grating with recesses of different depths, the recess in the edge area is preferably formed with the optimal depth.

In a particularly preferred construction of the objective according to the invention, only the diffracted light of a given order, preferably of the positive or negative first order, of the diffractive element is used as achromatized, refraction-increasing light for imaging, and the diffracted light of other orders is scatter light or stray light which is not used.

In another advantageous construction of the objective according to the invention, a circular central cutoff diaphragm is provided on or near the diffractive element so as to be arranged concentric to the optical axis of the objective and its diameter is preferably selected in such a way that the zeroth order diffraction light which is not cut off by the mountings of the optical elements following the diffractive element is safely cut out. Therefore, the imaging characteristic of the objective according to the invention is not disadvantageously impaired by the diffraction light of the zeroth order. Of course, the diameter can also be selected so as to be at least equal to the diameter of the beam bundle exiting from the second optics group. In this way, it can be ensured in an advantageous manner that no zeroth order diffraction light will impair the imaging.

Further, in a preferred further development of the objective according to the invention, all refractive elements of the first optics group can have positive refractive power. In this way, it is possible that the first optics group, in its entirety, has a very high positive refractive power with a large aperture, so that the resolution is very high.

Further, the second optics group can have only elements with negative refractive power, so that the desired beam bundle which exits from the second optics group and which is preferably a parallel beam bundle can be generated by the second optics group in a simple manner.

In the following, the invention will be described in more detail by way of example with reference to the drawings.

### BRIEF DESCRIPTION OF THE DRAWINGS

In the drawings,

FIG. 1 shows a lens section of the optical construction of the microscope objective, according to the invention, including a tube unit;

FIG. 2 shows an enlarged view of the microscope objective shown in FIG. 1;

FIG. 3 is a chart showing the grating frequency of the diffractive element;

FIG. 4 shows a cross section through the microscope objective according to the invention; and

FIG. 5 is a schematic view illustrating the production of the diffractive optical element.

### DESCRIPTION OF THE PREFERRED EMBODIMENTS

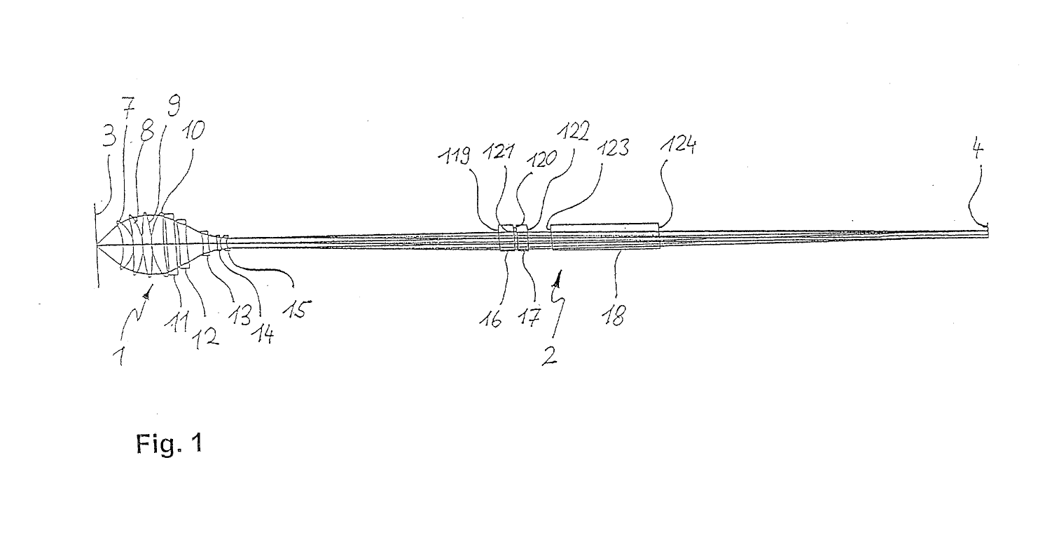

As can be seen from the lens section of the optical construction of a microscope shown in FIG. 1, a microscope objective 1 and a tube unit 2 following the latter are provided for imaging an object in the object plane 3 so as to be magnified in the image plane 4 (or intermediate image plane). The microscope objective 1 is a high-power objective that is used in microscopes for inspecting masks for semiconductor fabrication, for example. The microscope objective 1 described herein is achromatized for a spectral range of 193 nm±0.5 nm and has a magnification of 50 with a numerical aperture of 0.65 and a working distance of 7.8 nm, an object field diameter of 0.1 mm and an image field diameter of 5.0 mm.

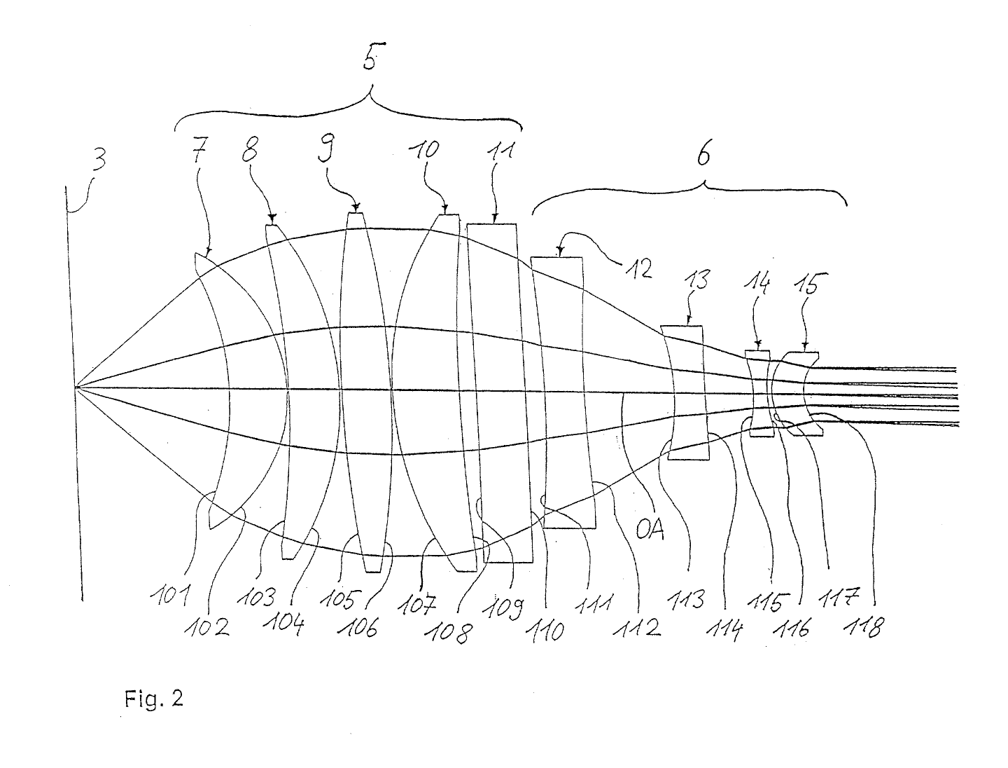

As can be seen most clearly in the enlarged view shown in FIG. 2, the microscope objective 1 contains a first optics group 5 on the object side with positive refractive power (or positive action) and a second optics group 6 following the first optics group 5 and having a negative refractive power (or negative action). All of the optical elements of both optics groups 5 and 6 are made from the same material, namely, Suprasil (synthetic quartz).

The first optics group 5 has, considered from left to right in FIG. 2, a first, second, third and fourth lens 7, 8, 9 and 10 and a diffractive optical element 11. A fifth, sixth, seventh and eighth lens 12, 13, 14 and 15 form the second optics group 6. The construction of the lenses 7 to 10 and 12 to 15 and the arrangement of all optical elements 7 to 15 of the microscope objective 1 are shown in the following Table 1.

TABLE 1

| Surface | Distance | | Radius | | Clear diameter |
|---|---|---|---|---|---|
| to surface | [mm] | Surface | [mm] | | [mm] |
| 3-101 | 10.1 | 101 | 19.525 | concave | 14.9 |
| 101-102 | 3.7 | 102 | 10.442 | concave | 16.4 |
| 102-103 | 0.1 | 103 | 58.714 | concave | 19.3 |
| 103-104 | 3.3 | 104 | 19.248 | concave | 20.1 |
| 104-105 | 0.15 | 105 | 66.836 | convex | 21.5 |
| 105-106 | 3.2 | 106 | 57.874 | concave | 21.7 |
| 106-107 | 0.1 | 107 | 20.684 | convex | 21.5 |
| 107-108 | 4.3 | 108 | 97.407 | convex | 20.7 |
| 108-109 | 1.1 | 109 | | plane | 20.4 |
| 109-110 | 3.2 | 110 | | plane | 17.6 |
| 110-111 | 1.3 | 111 | 81.748 | concave | 16.1 |
| 111-112 | 2.6 | 112 | 73.387 | convex | 13.6 |
| 112-113 | 5.9 | 113 | 15.07 | concave | 7.6 |
| 113-114 | 2.0 | 114 | 81.748 | convex | 6.5 |
| 114-115 | 3.16 | 115 | 7.718 | concave | 4.8 |
| 115-116 | 0.9 | 116 | 8.292 | convex | 4.5 |
| 116-117 | 0.3 | 117 | 3.599 | convex | 4.6 |
| 117-118 | 2.06 | 118 | 2.973 | convex | 3.6 |

As is shown in FIG. 1, the tube lens 2 has lenses 16, 17 and 18 whose construction and arrangement are shown in the following table.

TABLE 2

| Surface to surface | Distance [mm] | Surface | Radius [mm] |
|---|---|---|---|
| 118-119 | 99.87 | 119 | 107.46 convex |
| 119-120 | 5.7 | 120 | 42.17 concave |
| 120-121 | 1.13 | 121 | 40.388 concave |
| 121-122 | 3.8 | 122 | 281.84 concave |
| 122-123 | 9.0 | 123 | plane |
| 123-124 | 40.04 | 124 | plane |
| 124-4 | 120.65 | | |

The diffractive optical element 11 is a transmissive phase grating in which annular grooves are formed concentric to the optical axis OA of the objective 1 in the surface 109 facing the object plane 3.

The diffractive optical element 11 is so designed that, on the one hand, it causes increased refraction for the first optics group 5 (i.e., an increase in positive action or positive refractive power) and, on the other hand, it causes complete achromatization in the given spectral range (193 nm±0.5 nm) for the objective 1; in this case, the diffracted light of the positive first order is used as useful light for imaging. The diffracted light of other orders is scattered light which, as far as possible, should not contribute to the imaging so as not to impair it.

The first order diffraction in which a parallel beam (a beam parallel to the optical axis OA of the objective) is deflected toward the optical axis OA is referred to as positive first order. Conversely, the first order diffraction in which a parallel beam is diffracted away from the optical axis OA is referred to as negative first order diffraction.

The deflecting angle for the diffracted light of the positive first order is adjusted via the grating frequency of the diffractive optical element 11. In practice, the grating frequency can be calculated by means of optimization calculations based on the following phase polynomial p(r):

$$p ( r ) = {\sum }_{i = 1}^{N} {a}_{i} {r}^{2 i} ,$$

where r is the radial distance from the center M of the phase grating and N is a positive whole number greater than 1. The coefficients aᵢ are changed for purposes of optimizing. The phase polynomial p(r) gives the phase displacement as a function of the radial distance r and the grating frequency of the diffractive element can be calculated from the derivation of the phase polynomial according to the radial distance r. The angle of incidence can be calculated for every incident beam from this grating frequency, so that the achromatizing and refraction-increasing effect of the grating can be determined. Other aberrations of lenses 7 to 10 and 12 to 15 (e.g., higher spherical aberrations) can also be corrected in addition in this optimizing calculation, where a value of 3 to 10 is preferably selected for N.

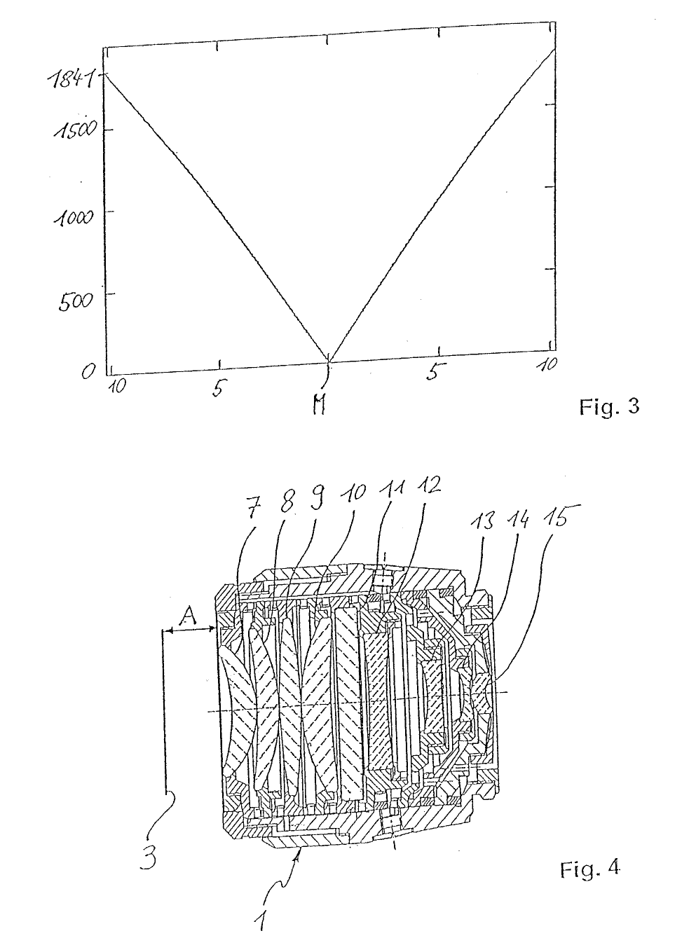

In FIG. 3, the curve of the grating frequency is shown in a central section of a diffractive optical element 11 which is optimized in the manner mentioned above. The distance from the center of the grating M is plotted on the abscissa (a graduation corresponds to 5 nm) and the quantity of lines (grooves) per mm is plotted on the ordinate, where the zero point lies at the intersection of the ordinate and abscissa and every graduation of the ordinate corresponds to 500 lines per mm. Thus it can be seen from FIG. 3 that the grating frequency increases from 0 lines per mm (in the center M) with increasing radial distance from the center M to the maximum frequency of 1841 lines per mm.

A theoretically optimal refraction efficiency can be achieved in a grating of the kind mentioned above when the depth of the individual recesses is selected so as to decrease with increasing radial distance of the recesses from the center, so that the depth of a recess in the edge area of the grating is less than the depth of a recess located farther inward. A grating of this kind can be produced easily in an advantageous manner by the holographic standing wave method described in the following, since the desired depth distribution is generated at the same time in this method. Alternatively, the grating can also be fabricated in such a way that all of the grooves preferably have the same depth, where the depth is fixed at the optimal value (e.g., 300 nm) for the edge area of the optical diffractive element 11, since the edge area, by reason of its larger surface compared to the center area of the grating, contributes most toward light collection and, therefore, also contributes the most toward diffraction efficiency. Further, the edge area contributes the most toward the resolution of the objective according to the invention. The grating with constant groove depth and the grating with variable depth can be formed by structuring methods known from semiconductor production, wherein a suitable lacquer coat applied to a substrate in which the grating is to be formed is exposed (e.g., by means of mask exposure or electron beam lithography) and structured. The structure in the lacquer coat is then transferred to the substrate by means of known methods (e.g., reactive ion etching). The desired grating can be formed with the required accuracy in this way.

As was already mentioned above, the diffracted light of the positive first order is used for imaging, so that the diffraction light of other orders represents unwanted scatter light. In order to ensure that this scatter light influences the imaging quality as little as possible, the diffractive optical element 11 in the first optics group 5 is arranged in the area of the greatest bundle diameter. In this way, a large part of the scatter light is already cut off at the mountings of the subsequent lenses 12 to 15 in which the bundle diameter is appreciably smaller, as can be seen from FIG. 2. Further, the scatter light which is not cut off by the mountings of the optical elements 12 to 15 following the diffractive optical element 11 exits the microscope objective 1 with an intersection length that is distinctly different from that of the diffracted light of the positive first order due to the high number of lines on the diffractive optical element 11, so that the scatter light is greatly expanded because of its convergent or divergent propagation on its way to the intermediate image located between the microscope objective 1 and the tube lens 2 and is accordingly extensively cut off at the mountings of the tube lens 2. The very small proportion which is not cut off at the tube lens 2 reaches the image only in a highly defocused manner, so that this does not lead to any appreciable impairment of imaging.

Further, the diffractive optical element 11 is so designed that it completely takes over the achromatization of the objective 1 in the given spectral area, so that all elements 7 to 15 of the microscope objective 1 can easily be made from the same material. Accordingly, the material which is best suited for the desired wavelength and which has, for example, the best transmission and/or is easiest to machine can be selected.

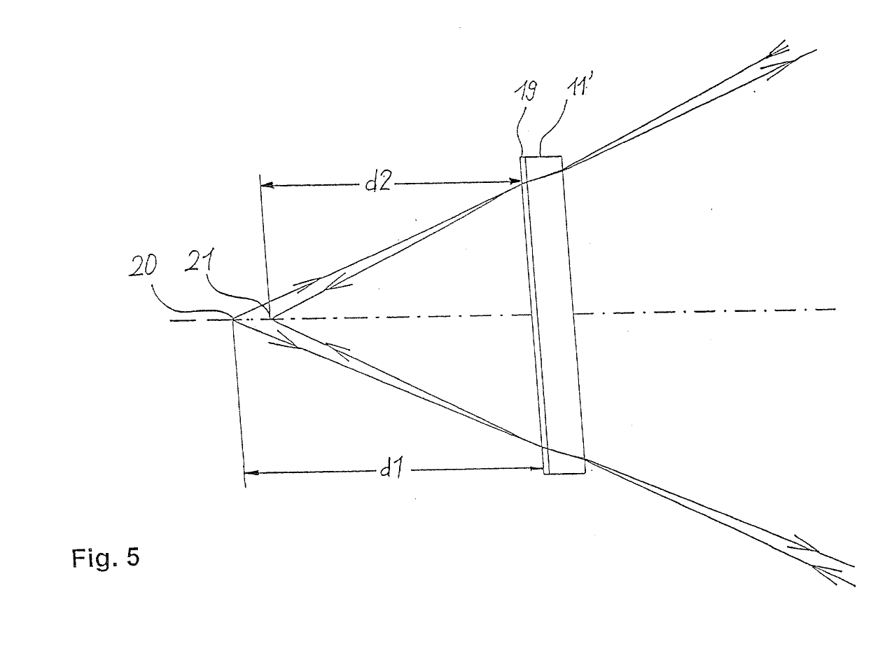

FIG. 4 shows a sectional view of the microscope objective 1 according to the invention, including the mountings at the optical elements 7 to 15. As can be seen immediately from the drawing, the microscope objective 1 is very compact and is constructed without cement and has a very small quantity of optical elements (7 to 15), a large working distance A of 7.8 mm and a numerical aperture of 0.65. In particular, because of the very short overall length of the microscope objective 1, it can also be used modularly in existing inspection systems.

The grating structure in surface 109 of the diffractive optical element 11 can be generated holographically. For this purpose, a lacquer coat 19 is applied to a surface of the plane-parallel plate 11′ (Suprasil) and is then exposed by means of the holographic standing wave method as is shown schematically in FIG. 5. The lacquer coat 19 is designed for an exposure wavelength of 458 nm and has a thickness of 200 to 500 nm.

In the holographic standing wave method, two coherent spherical waves (preferably laser radiation) which run toward one another are superimposed in such a way that the interference pattern occurring in the lacquer coat 19 leads to the exposure of the desired latent grating structure. The first spherical wave has its origin in point 20 and propagates toward the right with reference to FIG. 5. The second spherical wave propagates in the opposite direction of the first spherical wave, its focus being located at point 21. The distances d1, d2 of points 20 and 21 from the lacquer coat 19 are selected in such a way that the desired grating structure is exposed in the lacquer coat 19. The distance d1 of point 20 from the surface of the lacquer coat 19 is 22.776 mm and the distance d2 of point 21 from the surface of the lacquer coat 19 is 21.158 mm.

After the exposure of the lacquer coat 19, the latter is developed so that the lacquer coat 19 is structured and has the desired grating structure. This grating structure is then transferred by reactive ion etching (RIE) to the surface of the plane-parallel plate 11′ in such a way that the desired depth of the recesses is achieved. Any remaining residues of the lacquer coat 19 are then removed and the diffractive optical element 11 is finished.

A further improvement in the imaging characteristic of the objective according to the invention can be achieved in that a central cutoff diaphragm (not shown) which is arranged circularly and concentric to the optical axis OA is arranged on the surface 109 or 110 of the diffractive optical element 11. The diameter of this central cutoff diaphragm is preferably equal to the diameter of the beam bundle exiting from the second optics group 6. In this way, the zeroth order diffraction light from the central region around the optical axis OA is cut off and therefore does not enter the second optics group 6, so that an impairment of the imaging characteristic of the objective 1 due to the zeroth order diffraction light from the central region is prevented. The zeroth order diffraction light which is not intercepted by the cutoff diaphragm is cut off by the mountings of the lenses 12 to 15 arranged following the diffractive element 11, so that an advantageous improvement in the imaging characteristics can be achieved by means of the cutoff diaphragm.

While the foregoing description and drawings represent the present invention, it will be obvious to those skilled in the art that various changes may be made therein without departing from the true spirit and scope of the present invention.

What is claimed is:

1. An objective, in particular a microscope objective, comprising:
a first optics group with positive refractive power;
a second optics group with negative refractive power following the first optics group;
said first optics group containing a plurality of refractive elements; and said first optics group also containing at least one diffractive element with a refraction-increasing and achromatizing effect.

2. The objective according to claim 1, wherein the desired achromatization of the objective for a given wavelength range is caused completely by the at least one diffractive element.

3. The objective according to claim 1, wherein all of the optical elements of the two optics groups are formed from a maximum of two different materials.

4. The objective according to claim 3, wherein all of the optical elements of the two optics groups are formed from the same material.

5. The objective according to claim 1, wherein all of the optical elements of the two optics groups are held without cement.

6. The objective according to claim 1, wherein the maximum bundle diameter in the first optics group is greater than the maximum bundle diameter in the second optics group.

7. The objective according to claim 1, wherein the diffractive element is a grating which is rotationally symmetric with respect to the optical axis of the objective.

8. The objective according to claim 1, wherein the diffractive element is a transmissive phase grating.

9. The objective according to claim 7, wherein the grating frequency of the grating increases radially outward from the optical axis of the objective.

10. The objective according to claim 7, wherein the grating has annular recesses which are oriented concentric to the optical axis of the objective.

11. The objective according to claim 10, wherein all recesses are constructed with identical depth.

12. The objective according to claim 10, wherein the depth of the individual recesses decreases with increasing radial distance of the recess from the optical axis of the objective.

13. The objective according to claim 7, wherein the grating is formed on one side of a plane-parallel plate.

14. The objective according to claim 7, wherein the grating is formed on an optical working surface of one of the refractive elements of the first optics group.

15. The objective according to claim 7, wherein the grating is a blazed grating.

16. The objective according to claim 7, wherein the at least one diffractive element is arranged in the area with the largest bundle diameter in the first optics group.

17. The objective according to claim 1, wherein the diffracted light of a predetermined order of the diffractive element is used for imaging.

18. The objective according to claim 17, wherein the diffracted light of a predetermined order or is of a positive or negative first order.

19. The objective according to claim 1, wherein the diffractive element has a circular central cutoff diaphragm which is arranged concentric to the optical axis of the objective, wherein its diameter is preferably selected in such a way that it is at least equal to the bundle diameter of the beam bundle exiting from the second optics group.

20. The objective according to claim 1, wherein its numerical aperture is greater than 0.5 and its working distance is greater than 6 mm.

21. The objective according to claim 1, wherein all refractive elements of the first optics group have positive refractive power.

22. The objective according to claim 1, wherein the second optics group has only elements with negative refractive power.
